(19) United States
(12) Patent Application Publication
(10) Pub. No.: US 2024/0048569 A1
(43) Pub. Date: Feb. 8, 2024

(54) Digital certificate malicious activity detection

(71) Applicant: Sophos Limited, Abingdon (GB)

(72) Inventors: Hardik Shah, Bangalore (IN); Felix Benoit Roger Weyne, Kortrijk (BE); Stephen Matthew Ormandy, York (GB)

(21) Appl. No.: 17/880,820

(22) Filed: Aug. 4, 2022

(51) Int. Cl. H04L 9/40

(52) U.S. Cl. CPC H04L 63/1416; H04L 63/168; H04L 63/0823

(57) ABSTRACT

Systems and methods for detecting malicious activity. The methods include receiving at an interface at least one feature of a digital certificate; detecting, using one or more processors executing instructions stored on memory, an anomaly in the at least one feature of the digital certificate; identifying, using the one or more processors, at least one process or file associated with the digital certificate upon detecting the anomaly in the at least one feature; and analyzing, using the one or more processors, at least one property associated with the at least one identified process or file. The methods further include identifying, using the one or more processors, the at least one process or file as malicious based on the analysis of the at least one property associated with the at least one process or file and the identification of the anomaly in the at least one feature of the digital certificate; and executing at least one remedial action upon identifying the at least one process or file as malicious.

### TECHNICAL FIELD

The present application relates generally to systems and methods for detecting malicious network activity and, more particularly but not exclusively, to systems and methods for detecting malicious network activity based at least in part on digital certificates.

### BACKGROUND

Malicious actors may attempt to intercept communications of unsuspecting entities in furtherance of a malicious campaign. For example, malicious actors may attempt to intercept data such as usernames, passwords, financial information, or the like, and use the intercepted data for fraudulent or malign purposes.

Encryption can help protect network communications from malicious actors. Encryption generally involves transforming data into a different form before sending it to a receiving entity, and then transforming the data into its original or decrypted form so the receiving entity can view the communication. To decrypt the encrypted communication, a recipient of the encrypted communication may need a decryption key to decrypt and read the encrypted communication in a plain text format. Ideally, only intended entities possess the decryption key required for decryption.

While encryption can protect communications transmitted over a network for legitimate entitles and purposes, it can also be used by malware or by malicious actors to conceal their communications. This poses challenges to security vendors, as it becomes more difficult for them to detect malicious network activity. For example, Intrusion Protection Systems (IPS) operate by comparing network activity to signatures. This approach relies on plain-text pattern matching, and becomes impractical for encrypted communications.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

Embodiments herein provide systems and methods for detecting malicious network activity. The embodiments herein detect malicious activity based at least in part on one or more features of a digital certificate such as a Secure Sockets Layer (SSL) certificate.

If a digital certificate includes one or more anomalous features, the embodiments herein then identify one or more processes or files associated with the digital certificate. These may be processes or files on a network endpoint device, for example. The systems and methods herein then consider one or more behavioral properties of the processes or files, and calculate a score based on said property(ies). The score may represent the presence of and potential severity of anomalies detected in the behavioral property(ies).

If the score exceeds a threshold, the embodiments herein may designate the process or file as malicious. The embodiments herein may then implement one or more remedial actions in response to the identification of the process or file as malicious.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a block diagram of a threat management system in accordance with one embodiment;

FIGS. 2A-D illustrate an SSL handshake procedure in accordance with one embodiment;

FIG. 3 illustrates a system for detecting malicious activity in accordance with one embodiment;

FIG. 4 illustrates the certificate analysis module of FIG. 3 in accordance with one embodiment;

FIGS. 5A & 5B present tables of known malware families and their associated certificate features in accordance with one embodiment;

FIG. 6 illustrates the behavioral analysis module of FIG. 3 in accordance with one embodiment; and

FIG. 7 depicts a flowchart of a method for detecting malicious activity in accordance with one embodiment.

### DETAILED DESCRIPTION

Various embodiments are described more fully below with reference to the accompanying drawings, which form a part hereof, and which show specific embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

As discussed above, existing techniques for detecting network threats may involve matching network activity to a signature representative of malware or other type of malicious activity. Malicious actors, however, may leverage encryption techniques to conceal their communications.

For example, a malicious actor that has gained access to a server or other type of endpoint device may try to exfiltrate data therefrom to a command-and-control server. Exfiltration attempts and associated communications may have certain characteristics, but become difficult to identify if these communications are encrypted.

Accordingly, the benefits commonly associated with encryption can work against security vendors as they are unable to detect malicious, yet encrypted communications. For example, signature matching generally relies on plain-text pattern matching, which becomes impractical for encrypted communications. Normally, an entity that is not an intended recipient of a communication will not have the decryption key required to decrypt the communication. While decrypting encrypted communications without the decryption key is possible, key-less decryption techniques such as brute-force techniques are generally resource-intensive, time-consuming, and unreliable.

The embodiments herein provide novel systems and methods to detect malicious activity. The embodiments herein first consider one or more features of a digital certificate such as an SSL certificate. Certification authorities issue digital certificates to servers upon request, and the servers use the issued digital certificates to verify their identity. When a user attempts to access a server (e.g., to visit a web page) their web browser receives the server's digital certificate, which verifies the server's identity. Accordingly, the user knows they are visiting an authenticated web page or otherwise the web page that they intended to visit.

Digital certificates vary across different servers and certification authorities, but they tend to include similar features. These features may include, for example and without limitation, the issuing certification authority, the owner's name, a common name of the owner, the owner's country, the owner's city, a device's IP address, etc. Digital certificates also contain a copy of a public key issued by the certification authority. In operation, the public key is matched with a corresponding private key as part of the verification process between a client device and the server.

There are minimal requirements to receive a certificate from a certification authority. Requesting entities need to submit a public key and information to be validated. Requesting entities may include companies, websites, and individuals—including malicious actors.

The embodiments herein consider one or more of the features of a digital certificate. There may be expectations about features a benign or legitimate certificate should include. Similarly, anomalies or deviations from these expectations may suggest the server associated with the certificate is engaged in malicious activity.

Accordingly, the systems and methods described herein consider whether one or more features in a digital certificate are anomalous. For example, and as discussed below, the “owner city” value of a certificate may be a city that is associated with malicious activity or at the very least is suspicious, different than what is expected, or is otherwise anomalous.

Upon detecting one or more anomalous features in a digital certificate, the embodiments herein may identify one or more processes or files associated with the digital certificate. The embodiments herein calculate a score based on one or more behavioral properties of the identified process or file and, if the score exceeds a threshold, identify the process or file as malicious. The embodiments herein may then implement one or more remedial actions.

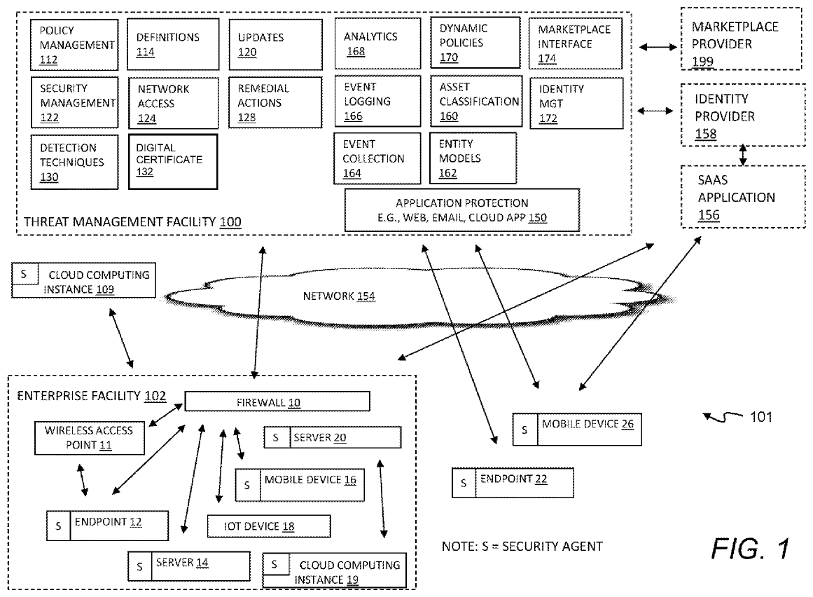

FIG. 1 illustrates a block diagram of a threat management system 101 providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 100 may communicate with, coordinate, and control operation of security functionality at different control points, layers, and levels within the threat management system 101. A number of capabilities may be provided by a threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In embodiments, the threat management facility 100 may provide protection from a variety of threats to a variety of compute instances in a variety of locations and network configurations.

As one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management system 101, the enterprise facility 102 may be or may include any networked computer-based infrastructure. For example, the enterprise facility 102 may be corporate, commercial, organizational, educational, governmental, or the like. As home networks become more complicated and include more compute instances at home and in the cloud, an enterprise facility 102 may also or instead include a personal network such as a home or a group of homes. The enterprise facility's 102 computer network may be distributed amongst a plurality of physical premises such as buildings on a campus, and located in one or in a plurality of geographical locations. The configuration of the enterprise facility as shown is by way of example, and it will be understood that there may be any number of compute instances, less or more of each type of compute instances, and other types of compute instances. As shown, the enterprise facility includes a firewall 10, a wireless access point 11, an endpoint 12, a server 14, a mobile device 16, an appliance or Internet-of-Things (IOT) device 18, a cloud computing instance 19, and a server 20. Again, the compute instances 10-20 depicted are by way of example, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include certain facilities, such as a policy management facility 112, security management facility 122, update facility 120, definitions facility 114, network access facility 124, remedial action facility 128, detection techniques facility 130, a digital certificate analyzer 132, application protection 150, asset classification facility 160, entity model facility 162, event collection facility 164, event logging facility 166, analytics facility 168, dynamic policies facility 170, identity management facility 172, and marketplace interface facility 174, as well as other facilities. For example, there may be a testing facility, a threat research facility, and other facilities (not shown). It should be understood that the threat management facility 100 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility 102. Some or all of one or more of the facilities 100, 112-174 may be provided on the same physical hardware or logical resource as a gateway, such as a firewall 10, or wireless access point 11. Some or all of one or more of the facilities 100, 112-174 may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider 199 may communicate with the threat management facility 100 via the marketplace interface facility 174 to provide additional functionality or capabilities to the threat management facility 100 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider 199 may be a specialized analytics provider; and so on. The marketplace provider 199, with appropriate permissions and authorization, may receive and send events, observations, inferences, controls, convictions, policy violations, or other information to the threat management facility 100. For example, the marketplace provider 199 may subscribe to and receive certain events, and in response, based on the received events and other events available to the marketplace provider 199, send inferences to the marketplace interface facility 174, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider 158 may be any system or entity that creates, maintains, and manages identity information for principals while providing authentication services to relying party applications, e.g., within a federation or distributed network. The identity provider 158 may, for example, offer user authentication as a service, where other applications, such as web applications, outsource the user authentication step(s) to a trusted identity provider.

In embodiments, the identity provider 158 may provide user identity information, such as multi-factor authentication, to a software-as-a-service (SaaS) application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 may inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as an endpoint 22 or other type of computing device outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop or other type of public location. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22 or 26 use a network that is outside of the enterprise facility 102 and separated from the enterprise facility 102, e.g., by a gateway, a public network, and so forth.

In some implementations, compute instances 10-26 may communicate with cloud applications, such as a SaaS application 156. The SaaS application 156 may be an application that is used by but not operated by the enterprise facility 102. Examples of commercially available SaaS applications 156 include Salesforce, Amazon Web Services (AWS) applications, Google Apps applications, Microsoft Office 365 applications and so on. A given SaaS application 156 may communicate with an identity provider 158 to verify user identity consistent with the requirements of the enterprise facility 102. The compute instances 10-26 may communicate with an unprotected server (not shown) such as a web site or a third-party application through an internetwork 154 such as the Internet or any other public network, private network or combination thereof.

In embodiments, aspects of the threat management facility 100 may be provided as a stand-alone solution. In other embodiments, aspects of the threat management facility 100 may be integrated into a third-party product. An application programming interface (e.g., a source code interface) may be provided such that aspects of the threat management facility 100 may be integrated into or used by or with other applications. For instance, the threat management facility 100 may be stand-alone in that it provides direct threat protection to an enterprise or computer resource, where protection is subscribed to the facility 100. Alternatively, the threat management facility 100 may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in a security agent of an endpoint 12, in a wireless access point 11 or firewall 10, as part of application protection 150 provided by the cloud, and so on.

In an embodiment, the security management facility 122 may provide for email security and control, for example to target spam, viruses, spyware and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an embodiment, security management facility 122 may provide for web security and control, for example, to detect or block viruses, spyware, malware, or unwanted applications; help control web browsing; and the like, which may provide comprehensive web access control to enable safe and productive web browsing. Web security and control may provide Internet use policies, reporting on suspect compute instances, security and content filtering, active monitoring of network traffic, Uniform Resource Identifier (URI) filtering, and the like. Aspects of the web security and control may be provided, for example, in the security agent of an endpoint 12, in a wireless access point 11 or firewall 10, as part of application protection 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data is made. Aspects of reputation filtering may be provided, for example, in the security agent of an endpoint 12, in a wireless access point 11 or firewall 10, as part of application protection 150 provided by the cloud, and so on. In embodiments, some reputation information may be stored on a compute instance 10-26, and other reputation data available through cloud lookups to an application protection lookup database, such as may be provided by application protection 150.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to the enterprise facility's 102 network, where one or more compute instances on the enterprise facility's 102 network may distribute updates to other compute instances.

The threat management facility 100 may include a policy management facility 112 that manages rules or policies for the enterprise facility 102. Examples of rules include access permissions associated with networks, applications, compute instances, users, content, data, and the like. The policy management facility 112 may use a database, a text file, other data store, or a combination to store policies. In an embodiment, a policy database may include a block list, a black list, an allowed list, a white list, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. These policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of Universal Serial Bus (USB) disks, and the policy management facility 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access.

The policy management facility 112 may also require update management (e.g., as provided by the update facility 120). Update management for the security management facility 122 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security management facility 122 and policy management facility 112 may push information to the enterprise facility 102 network and/or the compute instances 10-26, the enterprise facility 102 network and/or compute instances 10-26 may pull information from the security management facility 122 and policy management facility 112, or there may be a combination of pushing and pulling of information. For example, the enterprise facility 102 network and/or compute instances 10-26 may pull update information from the security management facility 122 and policy management facility 112 via the update facility 120, an update request may be based on a time period, by a certain time, by a date, on demand, or the like. In another example, the security management facility 122 and policy management facility 112 may push the information to the enterprise facility's 102 network and/or compute instances 10-26 by providing notification that there are updates available for download and/or transmitting the information. In an embodiment, the policy management facility 112 and the security management facility 122 may work in concert with the update facility 120 to provide information to the enterprise facility's 102 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 114 of the threat management facility 100 may manage definitions used to detect and remediate threats. For example, identity definitions may be used for scanning files, applications, data streams, etc. for the determination of malicious code. Identity definitions may include instructions and data that may be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22,26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an embodiment, the network access facility 124 may have access to policies that include one or more of a block list, a black list, an allowed list, a white list, an unacceptable network site database, an acceptable network site database, a network site reputation database, or the like of network access locations that may or may not be accessed by the client facility. Additionally, the network access facility 124 may use rule evaluation to parse network access requests and apply policies. The network access facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, macOS, OS X, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility 100 may include the entity model facility 162. The entity models may be used, for example, to determine the events that are generated by assets. For example, some operating systems may provide useful information for detecting or identifying events. For examples, operating systems may provide process and usage information that accessed through an application programming interface (API). As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19,109. Events may range in granularity. One example of an event is the communication of a specific packet over the network. Another example of an event may be identification of an application that is communicating over a network.

The event logging facility 166 may be used to store events collected by the event collection facility 164. The event logging facility 166 may store collected events so they may be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility Observations or inferences about events may also be logged by the event logging facility 166.

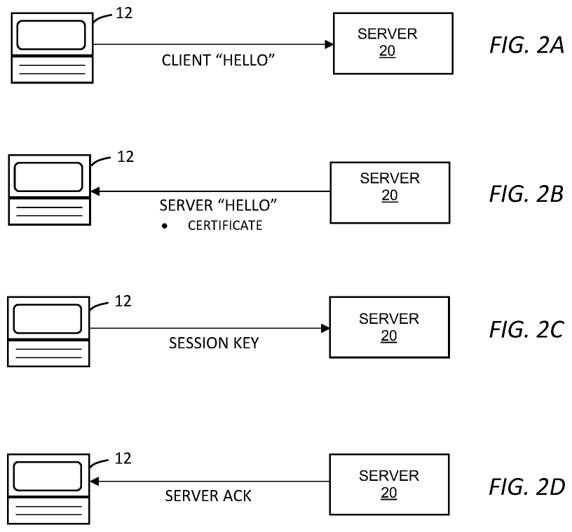

When a threat or other policy violation is detected by the security management facility 122, the remedial action facility 128 may remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 128 may take any steps or deploy any measures suitable for addressing a detection of a threat, potential threat, policy violation or other event, code or activity that might compromise security of a computing instance 10-26 or the enterprise facility 102 as identified by one or more of the facilities such as the policy management facility 112, security management facility 122, update facility 120, definitions facility 114, network access facility 124, detection techniques facility 130, digital certificate analyzer 132, application protection 150, asset classification facility 160, entity model facility 162, event collection facility 164, event logging facility 166, analytics facility 168, dynamic policies facility 170, identity management facility 172, as well as other facilities. For example, the digital certificate analyzer 132 may, as discussed below with reference to FIGS. 2-6, analyze one or more features of a digital certificate associated with an endpoint device.

As discussed previously, certification authorities issue digital certificates to servers, users, web sites, or the like. When a user attempts to access a website using a Secure Sockets Layer (SSL) connection, for example, they receive the associated server's digital certificate and know they are visiting an authenticated website or otherwise the desired website. A human user is generally oblivious to this handshake process.

FIGS. 2A-D illustrate a handshake procedure for a SSL connection, according to an example embodiment. In FIG. 2A a user operating a user device such as the endpoint 12 (or 22) of FIG. 1 attempts to access a website hosted by the server 20 of FIG. 1. Once the endpoint 12 submits the request, but before the website is displayed at the endpoint 12, the endpoint 12 communicates a “HELLO” message to the server 20 to attempt to establish a connection therewith. The endpoint 12 HELLO message may include, inter alfa, information about the endpoint 12, various settings, the endpoint's SSL version number, and other information needed to communicate with the endpoint 12.

As seen in FIG. 2B, the server 20 responds to the endpoint 12 with a server “HELLO” message. The server HELLO message may include the server's SSL version number and various settings pertaining to the server 20. The server HELLO message may also include the SSL certificate of the server 20 and a public key the endpoint 12 will need to communicate with the server 20 over SSL.

The certificate may include any one or more of a plurality of features related to the certificate owner, the certification authority, or both. Features related to the certificate owner may include, but are not limited to, the public key of the owner; a distinguished name (“DN”) of the owner, which is a unique identifier of the owner; a common name (“CN”) of the owner, and various location-related data of the owner such as country, city, and state. Features related to the certification authority may include, but are not limited to, the name of the certification authority that issued the certificate, the date on which the certificate was issued, the date on which the certificate will expire, and a private key or signature associated with the certification authority.

The endpoint 12 may then verify the received certificate. As mentioned above, the received digital certificate may include a public key of the certificate owner, which may be used for authenticating the certificate owner, and the signature of the certification authority. If the public key associated with the certificate is valid, the endpoint 12 may use the public key to extract the certification authority's signature, which authenticates the server 20. If the authentication fails, the endpoint 12 does not connect with the server 20.

If the authentication is successful, in FIG. 2C the endpoint 12 creates a session key. Before sending the session key, the endpoint 12 encrypts the key using the server's public key received in FIG. 2B.

Finally, in FIG. 2D the server 20 decrypts the received session key with its private key and sends an ACKNOWLEDGEMENT message to the endpoint 12. The connection is established and the website may be presented on the endpoint 12.

FIGS. 2A-D illustrate the process of how digital certificates may be used to verify the authenticity of a server. As noted above, these digital certificates may include several features relating to the owner of the certificate, the certification authority, or both.

The embodiments described herein may leverage this type of data to detect malicious activity. Specifically, the digital certificate analyzer 132 of FIG. 1 may analyze the features of a digital certificate such as the one discussed in conjunction with FIG. 2B. The analysis of these features provides a heuristic-based approach to detect malicious activity and does not rely on, for example, signature analysis or the decryption of communications.

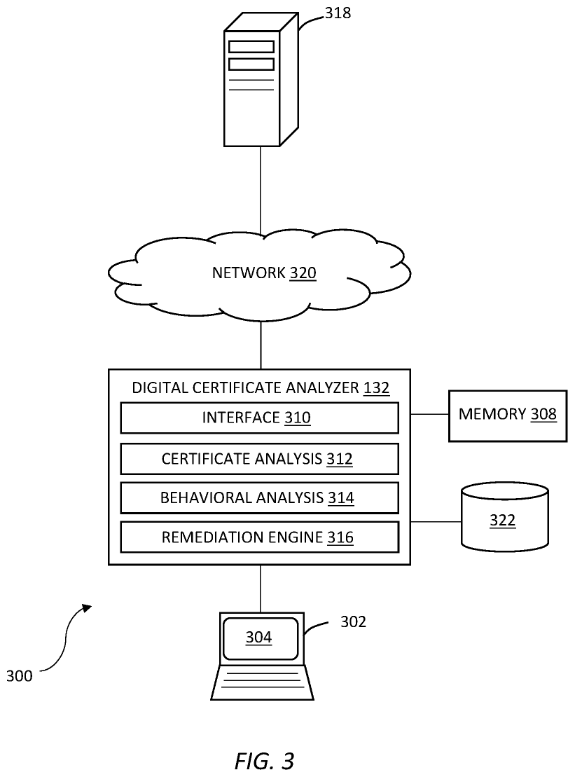

FIG. 3 illustrates a system 300 for detecting malicious activity using the digital certificate analyzer 132 of FIG. 1 in accordance with one embodiment. A user may access a user device 302 executing a user interface 304 to allow the user to access one or more network resources over a network. The user device 302 may be similar to the endpoints 12 or 22 of FIG. 1. In operation, the user may submit a request via the user interface 304 to access a web site hosted by a server. Alternatively, the user may be a malicious actor attempting to, for example, exfiltrate data from a network resource. The server 318 may be external from one or more of the servers previously discussed and may be operated may a third-party or entity different from the entity or owner of the threat management facility 100 and/or the enterprise facility 102. The server 318 may be operated by a malicious entity or may otherwise be used to communicate a fraudulent or malformed digital certificate to the user device 302.

The digital certificate analyzer 132 may include hardware and/or software components typically found in or otherwise associated with a computing device. For example, the digital certificate analyzer 132 may include one or more hardware and/or software processors that are executing, and/or configured to execute, computer-readable instructions stored on computer-readable memory 308 to configure the digital certificate analyzer 132. The digital certificate analyzer 132 may include a microprocessor, a field programmable gate array (FPGA), an application-specific integrated circuit (ASIC), or other similar devices.

In some embodiments, such as those relying on one or more ASICs, the functionality described as being provided in part via software may instead be configured into the design of the ASICs and, as such, the associated software may be omitted. The digital certificate analyzer 132 may be configured as part of a user device (e.g., a laptop) or located at some remote location.

The memory 308 may be L1, L2, L3 cache, or RAM memory configurations. The memory 308 may include non-volatile memory such as flash memory, EPROM, EEPROM, ROM, and PROM, or volatile memory such as static or dynamic RAM, as discussed above. The exact configuration/type of memory 308 may of course vary as long as instructions for detecting malicious activity may be performed by the digital certificate analyzer 132 to accomplish the features described herein.

The digital certificate analyzer 132 may include a communication interface 310, a certificate analysis module 312, a behavioral analysis module 314, and a remediation module 316. The communication interface 310 may be implemented in a variety of ways to at least receive the digital certificate. In some embodiments, the communication interface 310 may be implemented as a port or socket able to receive communications sent from the server 318. In some embodiments, the communication interface 310 may be implemented as a hardware interface such as a fiber optic interface, Universal Serial Bus (USB) interface, Ethernet interface, or any other type of interface whether available now or invented hereafter.

The digital certificate analyzer 132 may be in communication with one or more network endpoints such as servers 318 over one or more networks 320. For example, the digital certificate analyzer 132 may analyze features of received digital certificates and analyze behavioral data pertaining to processes or files such as those associated with the user device 302 or other endpoint device.

The digital certificate analyzer 132 may also be in communication with one or more databases 322. The databases 322 may store data regarding malware such as known malware families, their associated digital certificate features, data regarding processes known to be associated with malicious activity, data regarding files known to be associated with malicious activity, or the like.

The network(s) 320 may be similar to the network 154 of FIG. 1, and may link the various components with various types of network connections. The network(s) 320 may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network or networks 320 may also comprise, include, or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link, or a Time Division Multiple access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based link.

In some embodiments, the user device 302 may submit a request to access a resource on the server 318 or otherwise communicate with the server 318. In other embodiments, the user device 302 may be associated with a malicious actor. The interface 310 may receive the server's 318 digital certificate which, in some embodiments, may be an SSL certificate. The certificate analysis module 312 may then analyze one or more features of the received certificate.

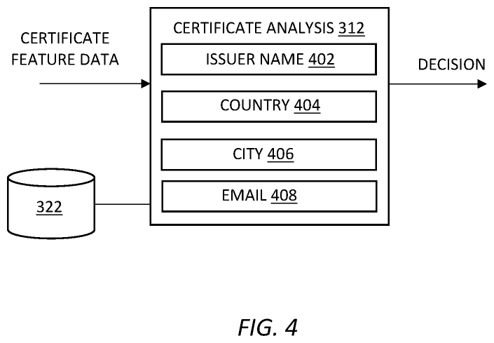

FIG. 4 illustrates the certificate analysis module 312 of FIG. 3 in accordance with one embodiment. As seen in FIG. 4 the certificate analysis module 312 may include, inter alia, an issuer name module 402 to analyze the value associated with the name attribute of the issuing certification authority, wherein the name attribute identifies the name of the issuing certification authority. The country analysis module 404 may analyze the value associated with the country attribute of the certificate holder, wherein the country attribute identifies the country in which the certificate holder is located. The city analysis module 406 may analyze the value associated with the city attribute of the certificate holder, wherein the city attribute identifies the city in which the certificate holder is located. The email analysis module 408 may analyze the value associated with the email address attribute of the certificate holder, wherein the email address attribute identifies the email address of the certificate holder.

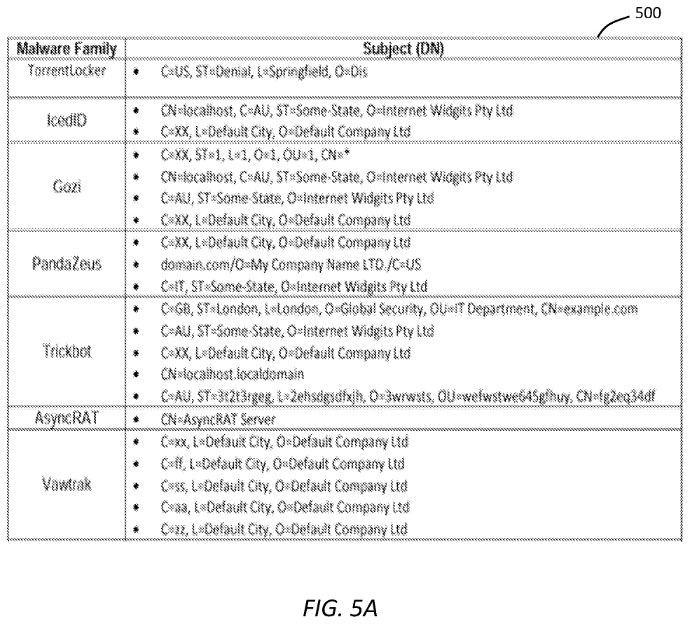

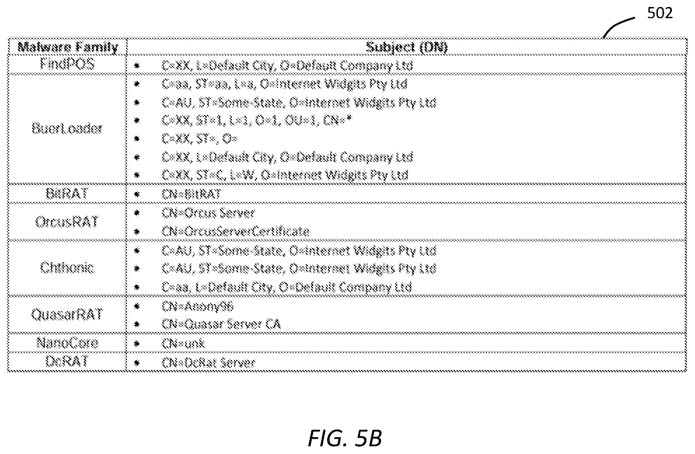

These analyses may involve comparing a attribute of a received digital certificate with an attribute that is known to be associated with a legitimate owner. For example, the database 322 may store records of various domain names or websites, including digital certificate features of those websites. The various modules 402-08 may reference these records to determine, for a particular web site under analysis, whether the features of the requested web site match those of the certificate of a known legitimate certificate or a known illegitimate certificate. For example, FIGS. 5A & 5B present tables 500 and 502, respectively, of known malware families and their associated certificate features. The certificate analysis module 312 or modules thereof may reference data such as that in tables 500 and 502.

As one example, the issuing certification authority attribute for the digital certificate associated with CNN.com has a value of “GlobalSign Atlas.” In other words, “Global Sign Atlas” is the name of the certification authority that issued the digital certificate for CNN.com.

Accordingly, this feature may be stored in the database 322 for future reference. In reviewing a digital certificate associated with a malicious website that attempts to resemble CNN.com, the issuer name module 402 may compare the name attribute value of the malicious website's digital certificate to the stored record associated with CNN.com. If the values do not match, it may suggest that this website is associated with malicious activity.

The above list of modules and analyzed features are discussed by way of example only. Other certificate features, whether used now or invented hereafter, may be used in accordance with the embodiments herein.

The certificate analysis module 312 may consider outputs of any one or more of the modules 402-08. For example, the certificate analysis module 312 may output a decision indicating that a certificate should be marked as anomalous if only one feature is anomalous. Alternatively, the certificate analysis module 312 may require that multiple certificate features are considered anomalous before outputting a decision that a certificate is anomalous.

As discussed above, the certificate analysis module 312 may also rely on data such as that of the tables 500 and 502. For example, if a certificate includes all features of a particular malware family, it may suggest the certificate is anomalous even if not all of the feature values match those of the malware family. Similarly, the more features with values that match values of a malware family, the more likely the certificate analysis module 312 will determine the feature(s) and the certificate are anomalous. The certificate analysis module 312 may check anomalies in the SSL certificate like default city, default company, or specific strings that may be related to malware such as BitRAT, Quasar, etc. If any strings specific to malware are found in a certificate, the certificate may be classified as anomalous.

Although the certificate analysis module 312 may identity certificates that are anomalous, this identification alone may not be helpful for a security vendor. For example, a security vendor may then want to know whether, and to what extent, files or processes associated with an anomalous certificate are also behaving anomalously. For example, a process that is associated with an anomalous certificate but is isolated on a single endpoint device may not be a concern. However, a process that is associated with an anomalous certificate that is attempting to contact other devices on a network may be more of a concern as it may be indicative of an exfiltration attempt.

Although a certificate may be classified as anomalous, it could be a false positive or otherwise not a cause for concern if no processes or files are also acting anomalously. There are many certification authorities that provide free SSL certificates for legitimate uses. However, malware authors also can easily obtain a certificate from these certification authorities. As a certificate can be used for legitimate purposes, a certificate feature alone may not be sufficient to determine if the communication is malicious or not.

Accordingly, the embodiments described herein may consider one or more process or file behavioral properties to more accurately classify activity as anomalous. Upon the certificate analysis module 312 outputting an anomalous classification, the behavioral analysis module 314 may check various heuristics of one or more processes associated with an endpoint device, one or more files associated with an endpoint device, or some combination thereof.

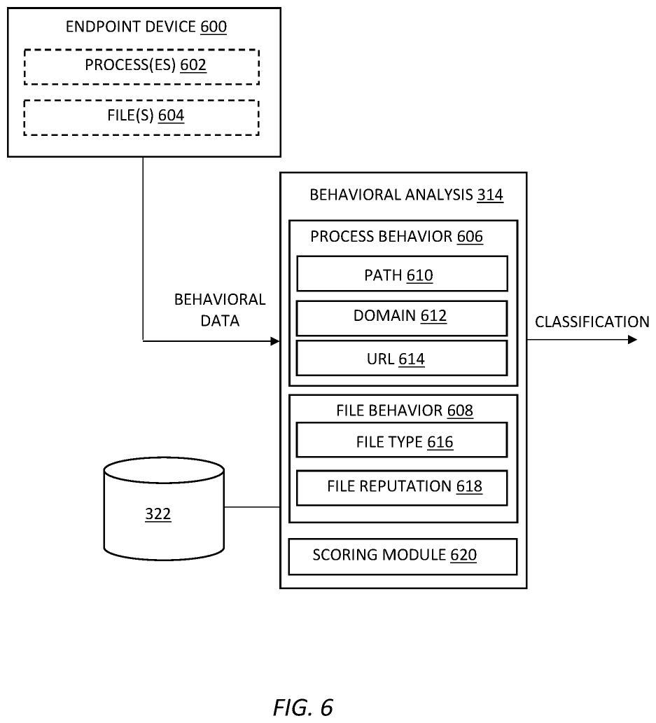

FIG. 6 illustrates the behavioral analysis module 314 of FIG. 3 in communication with an endpoint device 600 in accordance with one embodiment. The endpoint device 600 may be any device on a network that, for example, is in communication with a server associated with a digital certificate that has been classified as anomalous.

The behavioral analysis module 314 may receive and analyze various types of behavioral properties associated with processes 602, files 604, or both. For example, to analyze process-related behavior, the behavioral analysis module 314 may include a process behavior module 606. To analyze file-related behavior, the behavioral analysis module 314 may include a file behavior module 608.

The process behavior module 606 may execute one or more submodules to analyze data regarding a process executing or executable on the endpoint device 600. Characteristics associated with a process may indicate or at least suggest that a process is used for a malicious purpose.

For example, and without limitation, the process behavior module 606 may include or otherwise execute a path submodule 610 to determine and analyze the path from which a process executes. The path submodule 610 may reference the database 322 to compare a process path with expected process launch locations. For example, the database 322 may include one or more data structure such as a table or list that provides examples of expected launch locations for particular types of processes.

A domain reputation submodule 612 may analyze the reputation of a domain associated with the process. For example, the database 322 may include a data structure such as a table or a list storing data of known, malicious domains. The domain reputation submodule 612 may compare a domain associated with process with the lists or tables of known, malicious domains to determine whether the domain associated with the process matches or is at least similar to a known, malicious domain to warrant suspicion.

A uniform resource locator (URL) reputation submodule 614 may analyze the reputation of a URL associated with the process. The reputation submodule 614 may reference a data structure in the database 322 such as a table or list of known, malicious URLs. The reputation submodule 614 may compare the URL associated with the process to determine if it matches a known, malicious URL or is at least similar to a known malicious URL to warrant suspicion.

The file behavior module 608 may execute one or more submodules to analyze data regarding a file 604 on the endpoint device 600. For example, and without limitation, the file behavior module 608 may include or otherwise execute a file type submodule 616 to analyze the type of a file. The file type submodule 616 may reference a data structure in the database 322 such as a table or a list of file types commonly associated with malware. Malware may execute through file types such as executable files (“.exe”), Rich Text Format (“RTF”) files, and Virtual Basic Script (“VBS”) files. Accordingly, the file type submodule 616 may compare the file's type with types commonly associated with malware. If an analyzed file is of the same type of file types commonly associated with malware, it may suggest the file is used for a malicious purpose or is at least suspicious.

A file reputation submodule 618 may analyze the reputation of a file. The file reputation submodule 616 may reference a data structure in the database 322 such as a table or a list of files and their reputations. For example, the database 322 may store records such as those established by the Talos Security Intelligence and Research Group (TALOS). Accordingly, the file reputation submodule 618 may reference this type of reputation data to determine whether a particular file is similar to files that have a “bad” reputation, such as those that are commonly used for malicious purposes.

These submodules are discussed by way of example only. Other types of submodules and behavior data or heuristics in addition to or in lieu of those discussed above may be used in accordance with the embodiments herein.

The behavioral analysis module 314 or components thereof may reference one or more databases 322 in performing the behavioral property analysis. For example, the database(s) 322 may store reputation data of various processes, files, domains, etc., that the behavioral analysis module 314 references as part of its analysis.

The behavioral analysis module 314 may also include or otherwise execute a scoring module 620. The scoring module 620 may calculate a score representing the degree of maliciousness of a process or file. The scoring module 620 may consider outputs of any one or more of the various submodules discussed above.

For example, each submodule may output a “vote” of whether its associated behavioral property indicates or likely indicates the process or file is malicious. The score may be based on a cumulative number of votes, for example. Additionally, or alternatively, each of the behavioral properties may be weighted. For example, if a particular property is heavily weighted, the scoring module 620 may calculate a higher score even if the heavily weighted behavioral property is the only one that suggests a process or file is malicious.

Accordingly, the scoring module 620 may calculate a weighted average W, for example, calculated by:

$$W = \frac{{\sum }_{i = 1}^{n} {ω}_{i} {X}_{i}}{{\sum }_{i = 1}^{n} {ω}_{i}}$$

where: W is the calculated weighted average (i.e., the overall score):
n is the number of individual property scores to be averaged,
ωᵢ are the weights applied to each property score, and
Xᵢ is the data values to be averaged.

The weights assigned to each of the above-discussed process and file properties may vary and may depend on the application, the environment, the security vendor's preferences, or some combination thereof. For example, a security vendor may place higher weights on properties such as URL reputation and file reputation, as these properties may tend to accurately classify a process or file as malicious. That is, if the URL associated with a process under analysis matches a URL that is known to be malicious, there is a high likelihood that the analyzed process is used for a malicious purpose.

On the other hand, a security vendor may assign a lower weight (e.g., less than 1.0) to properties that may not be as accurate in predicting whether a process or file is associated with malicious activity. For example, executable files are commonly used in operating systems, and their presence may not necessarily be indicative of malicious activity.

The calculated score may be compared to a threshold score. If the calculated score exceeds the threshold score, the behavioral analysis module 314 may output a classification that the process or file is malware or is otherwise associated with malicious activity.

A security vendor may also customize the scoring module 620 to vary the threshold score. In some embodiments, the threshold score may be adjusted lower such that the system 300 is more sensitive and likely to identify activity as malicious. Similarly, a security vendor may adjust the threshold score higher to be more selective in identifying activity as malicious.

In some embodiments, this threshold may be adjusted autonomously or at least semi-autonomously. For example, a security vendor may provide feedback regarding classifications such as whether a classification was a false positive. If the security vendor has indicated one or more classifications were false positives, the threshold score may be adjusted higher so that there will be fewer malicious classifications. Similarly, if the security vendor has indicated one more malicious classifications were false negatives, the threshold score may be adjusted lower so that there will be more malicious classifications.

Referring back to FIG. 3, the remediation module 316 may then initiate one or more remediation procedures to mitigate the effect of the detected malware. For example, and without limitation, the remediation module 316 may drop the network connection between an endpoint device and a server associated with the analyzed digital certificate. As another example, the remediation module 316 may remediate files associated with the process. As yet another example, the remediation module 316 may generate an alert to notify a user or administrator about the detected malware. The alert may be visual alert, an audio alert, a haptic-based alert, or some combination thereof. Additionally, the remediation module 316 may be similar to and perform the same functions as the remedial action facility 128 of FIG. 1 discussed above.

Once a process or file is marked as malicious, a hash of the file or process and other details may be stored in the one or more databases 322. Accordingly, the system 300 may leverage this data to help identify malware in the future.

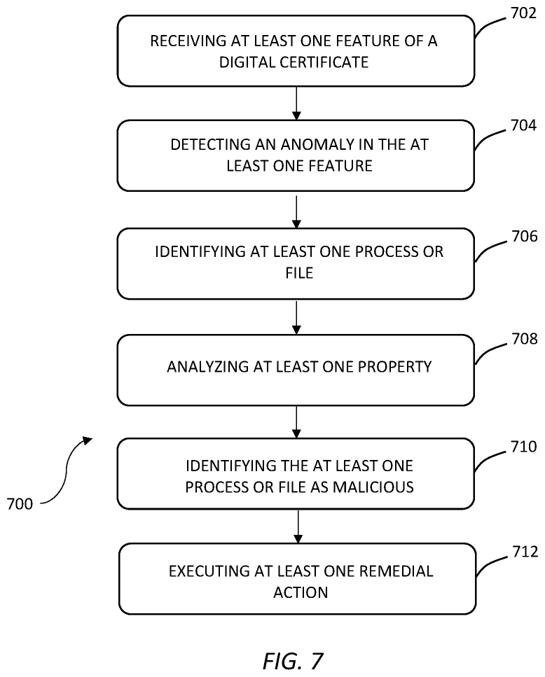

FIG. 7 depicts a flowchart of a method 700 for detecting malicious activity in accordance with one embodiment. The system 300 of FIG. 3 or components thereof may perform the steps of method 700.

Step 702 involves receiving at an interface at least one feature of a digital certificate. As discussed previously, the digital certificate may be an SSL certificate.

Step 704 involves detecting, using one or more processors executing instructions stored on memory, an anomaly in the at least one feature of the digital certificate. For example, step 704 may involve comparing features of a digital certificate to features of certificates known to be associated with malware or malicious activity.

As discussed above, a digital certificate may include a plurality of features associated with the issuing certification authority, the owner of the certificate, or some combination thereof. In some embodiments, the analysis of a particular feature may involve comparing the feature to data known about a particular company, website, certificate owner, or the like.

An endpoint device such as the threat management facility 100 of FIG. 1 or, more specifically, the digital certificate analyzer 132 may identify a network communication over SSL for a process. The digital certificate analyzer 132 may then identify one or more anomalies in features, or values thereof, of the digital certificate as discussed previously.

An anomaly in a certificate may or may not be sufficient by itself to identify malicious activity. For example, a security vendor may then want to know whether, and to what extent, files or processes associated with an anomalous certificate are also behaving anomalously as discussed previously. Accordingly, the embodiments described herein may consider one or more process or file behavioral properties to more accurately classify activity as anomalous. Accordingly, step 706 involves identifying, using the one or more processors, at least one process or file associated with the digital certificate.

Step 708 involves analyzing, using the one or more processors, at least one property associated with the at least one identified process or file. These may be behavioral properties such as those described in conjunction with FIGS. 6. An endpoint device such as the threat management facility 100 of FIG. 1 or, more specifically, the digital certificate analyzer 132 may analyze the property(ies) associated with the identified process or file. Alternatively, the threat management facility 100 may further include a component separate from the digital certificate analyzer 132 to perform the behavioral analysis. Although several behavioral properties are illustrated in and discussed in conjunction with FIG. 6, other properties in addition to or in lieu of those discussed above may be considered.

Step 710 involves identifying, using the one or more processors, the at least one process or file as malicious based on the analysis of the at least one property associated with the at least one process or file and the identification of the anomaly in the at least one feature of the digital certificate. Step 710 may involve calculating a score for the process or file that, if exceeds a threshold, indicates the process or file is malicious.

Step 712 involves executing at least one remedial action upon identifying the at least one process or file as malicious. The executed remedial action(s) may include those discussed previously, such dropping the network connection associated with the certificate, cleaning files associated with the process, generating an alert to a security vendor, or some combination thereof.

As discussed above, encryption can be powerful tool to protect benign or non-malicious communications between legitimate users. However, malicious actors may encrypt their own communications in furtherance of a malicious campaign. This may frustrate the efforts of security vendors in analyzing communications associated with malicious actors and even detecting such communications.

The embodiments herein provide novel and improved systems and methods for detecting malicious activity. The embodiments herein may rely on features of a digital certificate and an analysis of behavioral properties of files or processes associated with the certificate.

Computing devices have limited resources, and it is therefore desirable to use these resources as efficiently as possible. In accordance with the embodiments herein, resources are not required to decrypt encrypted communications, which can be a difficult and resource-intensive process without the required decryption key. Additionally, resources are not required to generate signatures and compare the generated signatures with network activity to identify malicious activity.

Accordingly, the embodiments described herein not only require less time and computing resources than existing techniques for identifying malicious activity, but also provide a more comprehensive and heuristic approach than is available with existing techniques. By considering certificate features and behavioral properties, the embodiments herein are able to more accurately identify malicious activity, thereby protecting computing resources from being affected by malicious activity.

According to one aspect, embodiments relate to a method for detecting malicious network activity. The method includes receiving at an interface at least one feature of a digital certificate; detecting, using one or more processors executing instructions stored on memory, an anomaly in the at least one feature of the digital certificate; identifying, using the one or more processors, at least one process or file associated with the digital certificate upon detecting the anomaly in the at least one feature; analyzing, using the one or more processors, at least one property associated with the at least one identified process or file; identifying, using the one or more processors, the at least one process or file as malicious based on the analysis of the at least one property associated with the at least one process or file and the identification of the anomaly in the at least one feature of the digital certificate; and executing at least one remedial action upon identifying the at least one process or file as malicious.

In some embodiments, the digital certificate is a Secure Sockets Layer (SSL) certificate.

In some embodiments, identifying the at least one process or file as malicious includes calculating a score for the at least one process or file based on the analysis of the at least one property associated with the at least one process or file, determining whether the calculated score exceeds a threshold value, and identifying the at least one process or file as malicious upon determining the calculated score exceeds the threshold value.

In some embodiments, receiving the at least one feature of the digital certificate includes identifying a network communication that uses a Secure Sockets Layer (SSL) protocol and obtaining an SSL certificate associated with the network communication.

In some embodiments, the at least one property associated with the identified at least one process or file includes at least one of a reputation of an executable file associated with the process, a path from which the process is executing, and a reputation of a domain associated with the process.

In some embodiments, the at least one feature of the digital certificate includes at least one of issuer name, issuer country, or issuer email address.

In some embodiments, the process is identified as malicious without decrypting traffic associated with the network communication.

According to another aspect, embodiments relate to a system for detecting malicious network activity. The system includes an interface for receiving at least one feature of a digital certificate; one or more processors executing instructions stored on memory to detect an anomaly in the at least one feature of the digital certificate; identify at least one process or file associated with the digital certificate upon detecting the anomaly in the at least one feature, analyze at least one property associated with the at least one identified process or file, identify the process as malicious based on the analysis of the at least one property associated with the at least one process or file and the identification of the anomaly in the at least one feature of the digital certificate, and execute at least one remedial action upon identifying the at least one process or file as malicious.

In some embodiments, the digital certificate is a Secure Sockets Layer (SSL) certificate.

In some embodiments, the one or more processors are configured to identify the at least one process or file as malicious by calculating a score for the at least one process or file based on the analysis of the at least one property associated with the process or file, determining whether the calculated score exceeds threshold value, identifying the at least one process or file as malicious upon determining the calculated score exceeds the threshold value.

In some embodiments, the one or more processors are further configured to identify a network communication that uses a Secure Sockets Layer (SSL) protocol and obtain an SSL certificate associated with the network communication.

In some embodiments, the at least one property associated with the identified at least one process or file includes at least one of a reputation of an executable file associated with the process, a path from which the process is executing, and a reputation of a domain associated with the process.

In some embodiments, the at least one feature of the digital certificate includes at least one of issuer name, issuer country, and issuer email address.

In some embodiments, the one or more processors identify the process as malicious without decrypting traffic associated with the network connection.

According to yet another aspect, embodiments relate to a computer program product for detecting malicious network activity, the computer program product comprising computer executable code embodied in one or more non-transitory computer readable media that, when executing on one or more processors, performs the steps of receiving at an interface at least one feature of a digital certificate; detecting, using one or more processors executing instructions stored on memory, an anomaly in the at least one feature of the digital certificate; identifying, using the one or more processors, at least one process or file associated with the digital certificate upon detecting the anomaly in the at least one feature; analyzing, using the one or more processors, at least one property associated with the at least one identified process or file; identifying, using the one or more processors, the at least one process or file as malicious based on the analysis of the at least one property associated with the at least one process or file and the identification of the anomaly in the at least one feature of the digital certificate; and executing at least one remedial action upon identifying the at least one process or file as malicious.

In some embodiments, the digital certificate is a Secure Sockets Layer (SSL) certificate.

In some embodiments, the computer program product further includes computer executable code that, when executing on one or more processors, identifies the at least one process or file as malicious by calculating a score for the at least one process or file based on the analysis of the at least one property associated with the at least one process or file, determining whether the calculated score exceeds threshold value, and identifying the at least one process or file as malicious upon determining the calculated score exceeds the threshold value.

In some embodiments, the computer program product further includes computer executable code that, when executing on one or more processors, performs the steps of identifying a network communication that uses a Secure Sockets Layer (SSL) protocol and obtaining an SSL certificate associated with the network communication.

In some embodiments, the at least one property associated with the identified at least one process or file includes at least one of a reputation of an executable file associated with the process, a path from which the process is executing, and a reputation of a domain associated with the process.

In some embodiments, the at least one feature of the digital certificate includes at least one of issuer name, issuer country, and issuer email address.

In accordance with the above, the embodiments herein provide novel systems and methods for detecting malicious activity. The systems and methods herein rely on a heuristic approach to detect malicious activity based on digital certificates and associated process or file behavior.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for detecting malicious network activity, the method comprising:
receiving at an interface at least one feature of a digital certificate;
detecting, using one or more processors executing instructions stored on memory, an anomaly in the at least one feature of the digital certificate;
identifying, using the one or more processors, at least one process or file associated with the digital certificate upon detecting the anomaly in the at least one feature;
analyzing, using the one or more processors, at least one property associated with the at least one identified process or file;
identifying, using the one or more processors, the at least one process or file as malicious based on the analysis of the at least one property associated with the at least one process or file and the identification of the anomaly in the at least one feature of the digital certificate; and
executing at least one remedial action upon identifying the at least one process or file as malicious.

2. The method of claim 1 wherein the digital certificate is a Secure Sockets Layer (SSL) certificate.

3. The method of claim 1 wherein identifying the at least one process or file as malicious includes:
calculating a score for the at least one process or file based on the analysis of the at least one property associated with the at least one process or file,
determining whether the calculated score exceeds a threshold value, and
identifying the at least one process or file as malicious upon determining the calculated score exceeds the threshold value.

4. The method of claim 1 wherein receiving the at least one feature of the digital certificate includes:
identifying a network communication that uses a Secure Sockets Layer (SSL) protocol, and
obtaining an SSL certificate associated with the network communication.

5. The method of claim 1 wherein the at least one property associated with the identified at least one process or file includes at least one of a reputation of an executable file associated with the process, a path from which the process is executing, and a reputation of a domain associated with the process.

6. The method of claim 1 wherein the at least one feature of the digital certificate includes at least one of issuer name, issuer country, or issuer email address.

7. The method of claim 1 wherein the process is identified as malicious without decrypting traffic associated with the network communication.

8. A system for detecting malicious network activity, the system comprising:
an interface for receiving at least one feature of a digital certificate;
one or more processors executing instructions stored on memory to:
detect an anomaly in the at least one feature of the digital certificate,
identify at least one process or file associated with the digital certificate upon detecting the anomaly in the at least one feature,
analyze at least one property associated with the at least one identified process or file,
identify the process as malicious based on the analysis of the at least one property associated with the at least one process or file and the identification of the anomaly in the at least one feature of the digital certificate; and
execute at least one remedial action upon identifying the at least one process or file as malicious.

9. The system of claim 8 wherein the digital certificate is a Secure Sockets Layer (SSL) certificate.

10. The system of claim 8 wherein the one or more processors are configured to identify the at least one process or file as malicious by:
calculating a score for the at least one process or file based on the analysis of the at least one property associated with the process or file,
determining whether the calculated score exceeds threshold value, and
identifying the at least one process or file as malicious upon determining the calculated score exceeds the threshold value.

11. The system of claim 8 wherein the one or more processors are further configured to:
identify a network communication that uses a Secure Sockets Layer (SSL) protocol, and
obtain an SSL certificate associated with the network communication.

12. The system of claim 8 wherein the at least one property associated with the identified at least one process or file includes at least one of a reputation of an executable file associated with the process, a path from which the process is executing, and a reputation of a domain associated with the process.

13. The system of claim 8 wherein the at least one feature of the digital certificate includes at least one of issuer name, issuer country, and issuer email address.

14. The system of claim 8 wherein the one or more processors identify the process as malicious without decrypting traffic associated with the network connection.

15. A computer program product for detecting malicious network activity, the computer program product comprising computer executable code embodied in one or more non-transitory computer readable media that, when executing on one or more processors, performs the steps of:
receiving at an interface at least one feature of a digital certificate;
detecting, using one or more processors executing instructions stored on memory, an anomaly in the at least one feature of the digital certificate;
identifying, using the one or more processors, at least one process or file associated with the digital certificate upon detecting the anomaly in the at least one feature;
analyzing, using the one or more processors, at least one property associated with the at least one identified process or file;
identifying, using the one or more processors, the at least one process or file as malicious based on the analysis of the at least one property associated with the at least one process or file and the identification of the anomaly in the at least one feature of the digital certificate; and
executing at least one remedial action upon identifying the at least one process or file as malicious.

16. The computer program product of claim 15 wherein the digital certificate is a Secure Sockets Layer (SSL) certificate.

17. The computer program product of claim 15 further comprising computer executable code that, when executing on one or more processors, identifies the at least one process or file as malicious by:
calculating a score for the at least one process or file based on the analysis of the at least one property associated with the at least one process or file,
determining whether the calculated score exceeds threshold value, and
identifying the at least one process or file as malicious upon determining the calculated score exceeds the threshold value.

18. The computer program product of claim 15 further comprising computer executable code that, when executing on one or more processors, performs the steps of:
identifying a network communication that uses a Secure Sockets Layer (SSL) protocol, and
obtaining an SSL certificate associated with the network communication.

19. The computer program product of claim 15 wherein the at least one property associated with the identified at least one process or file includes at least one of a reputation of an executable file associated with the process, a path from which the process is executing, and a reputation of a domain associated with the process.

20. The computer program product of claim 15 wherein the at least one feature of the digital certificate includes at least one of issuer name, issuer country, and issuer email address.
